(19) United States
(12) Patent Application Publication
(10) Pub. No.: US 2014/0324363 A1
(43) Pub. Date: Oct. 30, 2014

(54) SYSTEM RELIABILITY ANALYSIS AND MANAGEMENT USING PHYSICS-BASED MODELS EMBEDDED IN A BAYSIAN NETWORK

(71) Applicant: UNITED TECHNOLOGIES CORPORATION, Hartford, CT (US)

(72) Inventor: Grant L. Reinman, Farmington, CT (US)

(73) Assignee: UNITED TECHNOLOGIES CORPORATION, Hartford, CT (US)

(21) Appl. No.: 14/264,593

(22) Filed: Apr. 29, 2014

Related U.S. Application Data
(60) Provisional application No. 61/817,628, filed on Apr. 30, 2013.

(51) Int. Cl. G01M 15/14; G06F 17/18

(52) U.S. Cl. CPC G01M 15/14; G06F 17/18
USPC 702/34

(57) ABSTRACT

A method for assessing reliability in a gas turbine engine system includes using a processor to carry out instructions from a memory to propagate a physics-based model through a Bayesian network to assess reliability for the gas turbine engine system. A system for assessing reliability for a gas turbine engine system includes a memory including instructions to propagate a physics-based model through a Bayesian network to assess reliability for a gas turbine engine system. The system also includes a processor operatively connected to the memory to carry out the instructions. A network interface can be operatively connected to the processor to receive reliability data from operation of gas turbine engines, wherein the memory includes instructions for updating data module or modules based on reliability data.

### CROSS REFERENCE TO RELATED APPLICATIONS

This application claims priority of U.S. Provisional Patent Application No. 61/817,628, filed Apr. 30, 2013, which is incorporated by reference herein in its entirety.

### BACKGROUND OF THE INVENTION

1. Field of the Invention

The present invention relates to reliability assessment, and more particularly to reliability assessment for gas turbine engines.

2. Description of Related Art

Traditionally reliability assessment for complex systems, such as gas turbine engines, have been based on empirical data. Typically Weibull life distributions are assigned to each engine component in a system reliability model in the early phases of engine design.

When a new engine design is being assessed, empirical data derived from operation of previous designs is used, and modified as seems appropriate based on the differences between the previous designs and the new design. This modified empirical data is used to assess reliability for the new engine design. Failure mechanisms are typically addressed independently.

Such assessment methods can be updated as the new design enters use and new empirical data becomes available. This enables traditional reliability assessments to improve in accuracy over time.

Such conventional methods and systems have generally been considered satisfactory for their intended purpose. However, there is still a need in the art for reliability assessment systems and methods that allow for improved accuracy, including before empirical data becomes available, and for accounting for coupled sources of uncertainty. There also remains a need in the art for such reliability assessment techniques that are easy to implement. The present invention provides a solution for these problems.

### SUMMARY OF THE INVENTION

The subject invention is directed to a new and useful method for assessing reliability in a gas turbine engine system. The method includes using a processor to carry out instructions from a memory to propagate a physics-based model through a Bayesian network to assess reliability for the gas turbine engine system.

In certain embodiments, the method includes updating the physics-based model and propagating the updated physics-based model through the Bayesian network to reassess reliability for the gas turbine engine system. The step of updating the physics-based model can be based on at least one of component life data, calibration data for the physics-based model, calibration data for at least one sub-model of the physics-based model, data collected in manufacturing for one or more model inputs, updated boundary conditions, updates to the physics-based model, or the like. It is also contemplated that the method can include propagating at least one empirical model through the Bayesian network in combination with the physics-based model to assess reliability of the gas turbine engine system.

Propagating the physics-based model through the Bayesian network can include using nodes of the Bayesian network to characterize elements influencing reliability of at least one gas turbine engine component, wherein the nodes are interconnected with directed edges that characterize relationships among the elements influencing reliability. Absence of a directed edge connecting between two of the nodes can be indicative of conditional independence of those nodes. The method can include collecting data from gas turbine engines in service and using the data to update the physics-based model.

In accordance with certain embodiments, propagating the physics-based model through the Bayesian network includes propagating a plurality of physics-based models through the Bayesian network. At least one of mission and performance can be updated for each of the physics-based models that is dependent on at least one of mission and performance. These updated physics-based models can be propagated through the Bayesian network to reassess reliability.

In another aspect, the method can include maintaining a data module for a gas turbine engine, for each critical part in a gas turbine engine, and/or for each critical module of parts in a gas turbine engine. Each data module can include data relevant to at least one of material, manufacture, assembly, green run, and service for the respective gas turbine engine, critical part, and/or critical module of parts. The method can include using the data modules to update the physics-based models. It is contemplated that the method can include receiving reliability data from operation of gas turbine engines and updating the data module or modules based on the reliability data.

The invention also provides a system for assessing reliability for a gas turbine engine system. The system for assessing reliability includes a memory with instructions to propagate a physics-based model through a Bayesian network to assess reliability for a gas turbine engine system. The system also includes a processor operatively connected to the memory to carry out the instructions. A network interface can be operatively connected to the processor to receive reliability data from operation of gas turbine engines, wherein the memory includes instructions for updating the data module or modules based on the reliability data as described above.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a schematic view of an exemplary embodiment of a system for assessing reliability constructed in accordance with the present invention, showing the processor, memory, and network interface operatively connected together;

FIG. 2 is a schematic view of an exemplary embodiment of a method of reliability assessment in accordance with the present invention, showing physics-based models propagated through a Bayesian network to provide a reliability assessment, which can be updated as the physics-based models, and/or their inputs, are updated to reassess reliability;

FIG. 3 is a schematic view of an exemplary Bayesian network, showing three nodes interconnected with directed edges; and

FIG. 4 is a schematic view of another exemplary embodiment of a Bayesian network in accordance with the present invention, showing nodes and directed edges for a system for determining turbine oxidation life capability in a gas turbine engine.

### DETAILED DESCRIPTION OF THE PREFERRED EMBODIMENTS

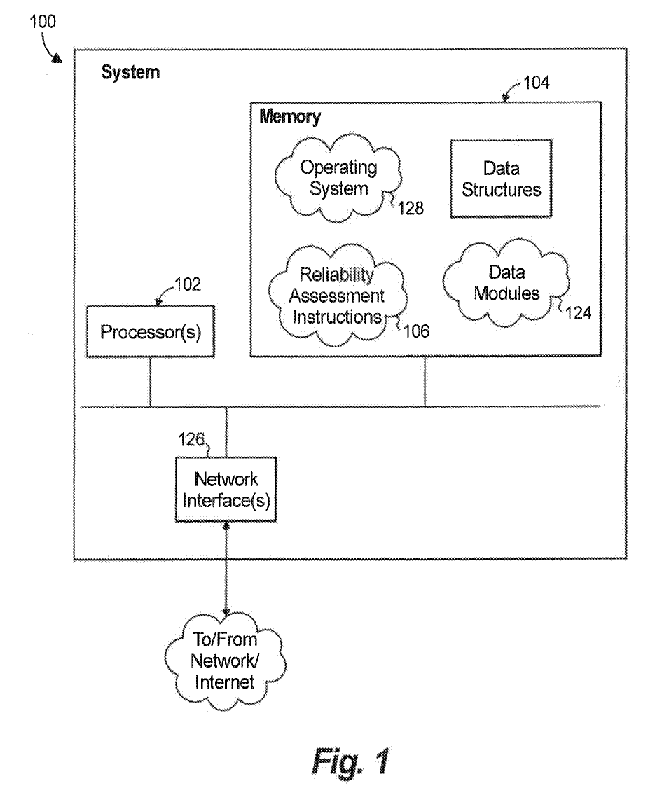

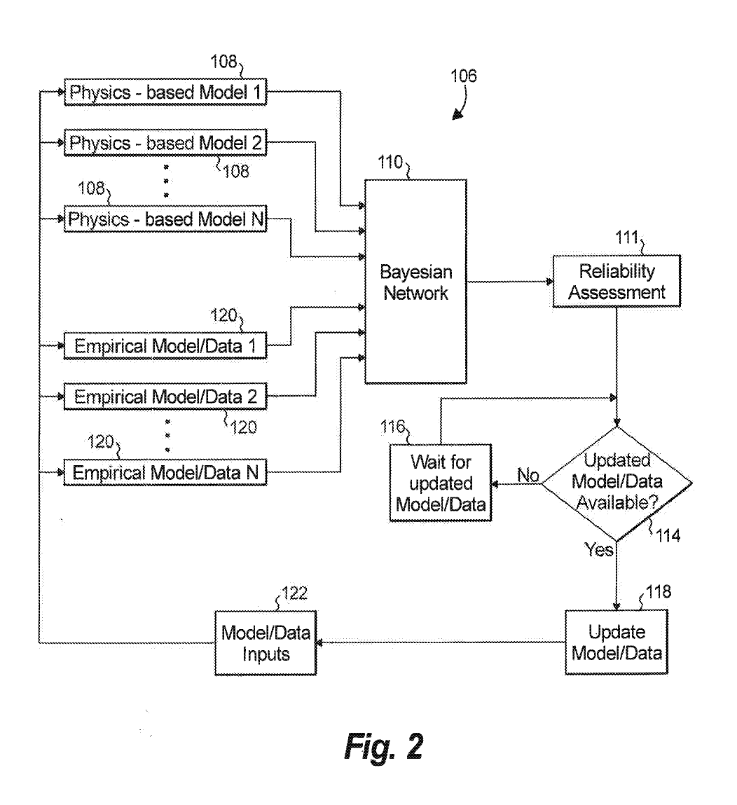

Reference will now be made to the drawings wherein like reference numerals identify similar structural features or aspects of the subject invention. For purposes of explanation and illustration, and not limitation, a partial view of an exemplary embodiment of a system for reliability assessment in accordance with the invention is shown in FIG. 1 and is designated generally by reference character 100. Other embodiments of reliability assessment in accordance with the invention, or aspects thereof, are shown in FIG. 2, as will be described. The systems and methods of the invention can be used to assess reliability, for example in gas turbine engines.

System 100 for assessing reliability in a gas turbine engine system includes using one or more processors 102 to carry out instructions 106 from memory 104 to propagate a physics-based model through a Bayesian network to assess reliability for the gas turbine engine system. Memory 104 includes instructions for updating the data module or modules based on reliability data as described below.

With reference now to FIG. 2 the method on which instructions 106 are based is depicted schematically. The method includes propagating one or more physics-based model(s) 108 through a Bayesian network 110 to provide a reliability assessment 112. After a reliability assessment 112 has been provided, it is possible to update the reliability assessment based on new information. The evaluation 114 of whether such updated information is available can lead to no update being made until such information does become available, as indicated schematically in FIG. 2 by the wait for updated model/data box 116. In the event that updated information is available, one or more of the physics-based model(s) 108 are updated, as indicated by update box 118, and propagated through Bayesian network 110 to reassess reliability for the gas turbine engine system. The model(s) themselves and/or the data input for the model(s) can be updated as indicated schematically by the connection between update box 118 and input box 122 in FIG. 2.

In the exemplary context of assessing reliability for gas turbine engine systems, the step of updating physics-based model(s) 108 can be based component life data, calibration data for one or more of the physics-based model(s) 108, calibration data for at least one sub-model of the physics-based model(s) 108, data collected in manufacturing for one or more model inputs, updated boundary conditions, updates to the physics-based model, updated mission, and/or performance. Any model that is dependent on the properties being updated can be updated and propagated through Bayesian network 110 for reassessment of reliability.

In addition to the physics-based model(s) 108, the method can optionally include propagating one or more empirical model(s) 120 through Bayesian network 110 in combination with the physics-based model(s) 108 to assess reliability of the gas turbine engine system. This can be useful in applications where physics-based models are not available, or as a redundancy with physics-based models, for example. The models and/or inputs 122 for the empirical and physics based models can be updated as needed and all of the models can be propagated through Bayesian Network 110. The models themselves may be updated, for example, if an improvement is made to one of the physics-based model(s) 108 or one of the empirical model(s) 120, the old model can be replaced with the improved model, which can then be propagated through Bayesian Network 110 to update reliability assessment 112.

Referring again to FIG. 1, a data module 124 can be maintained for each critical part or module of parts in a gas turbine engine. Data module(s) 124 are included in memory 104, which can be the memory of a single device, or combined memories of multiple devices. Each data module 124 can include data relevant to at least one of material, manufacture, assembly, green run, and service for the respective gas turbine engine, critical part, and/or critical module of parts. System 100 includes one or more network interface(s) 126 connected to receive reliability data from operation of gas turbine engines for use in updating the data module or modules based on the reliability data. Network interface(s) 126 connect between system 100 and a network such as an local network, the internet, or the like, where the reliability data originates. For example, an original engine manufacturer can collect reliability data from engine operators in the field via the internet.

Various events can give rise to an opportunity to update reliability assessment 112. For example, after an initial reliability assessment for a particular gas turbine engine design has been provided, the engine may be manufactured and put in to service. The manufacturing process, test stand performance, and performance in the field may all provide data that can be used to refine physics-based model(s) 108 and/or empirical model(s) 120. Data from gas turbine engines in service or during manufacture can be collected and used for such updates using a local network at the original engine manufacturer's facility for data derived on sight, for example, or using the internet for data coming in from off site, for engine operators in the field, for example.

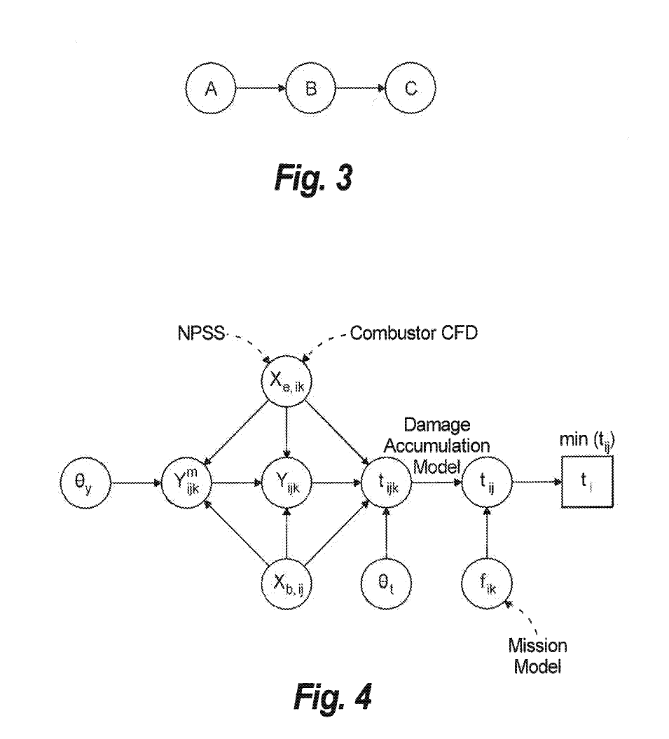

With reference now to FIGS. 3-4, exemplary Bayesian network configurations are described. Propagating the physics-based model(s) 108 through Bayesian network 106 includes using nodes of Bayesian network 110 to characterize elements influencing reliability of at least one gas turbine engine component, wherein the nodes are interconnected with directed edges that characterize relationships among the elements influencing reliability. Absence of a directed edge connecting between two of the nodes can be indicative of conditional independence of those nodes.

For example, in FIG. 3 directed acyclic graph (DAG) is shown for an exemplary Bayesian network. A directed graph is a collection of nodes and directed edges. The directed graph in this context is part of a Bayesian Network in which the circled nodes or vertices represent uncertain quantities. The absence of an edge between vertices is an assumption of conditional independence for the two nodes. The joint distribution of a set of nodes V in a Bayesian Network is

$$P ( V ) = {\prod }_{v ∈ V} p ( v \vert parents [ v ] )$$

where the parents of a node are the nodes that have an edge pointing toward that node. So the graph in FIG. 3 implies p(V)=p(A,B,C)=p(A)p(B|A)p(C|B).

FIG. 4 shows another exemplary DAG for distribution of time until the first blade in a turbine stage exceeds oxidation depth criteria. In this example, the reliability of a particular turbine stage is assessed. The failure mechanism of concern is airfoil oxidation. Reliability addresses the probability that the turbine stage will survive a certain number of hours or cycles when subjected to some specified usage. Therefore the interest lies in the probability distribution of the time until the turbine is removed from service due to the oxidation depth of any airfoil in the stage exceeding the allowable depth. For the i^{th} turbine in a hypothetical fleet, this uncertain time is referred to as tᵢ. Because the turbine is removed from service as soon as the first blade in the stage is oxidized beyond the allowable depth, the removal time is the minimum of the removal times of all blades in the stage. The removal time for blade j in engine i is denoted tᵢⱼ. A turbine stage installed in an engine in service will typically undergo a dynamic thermal stress environment, as opposed to a constant stress environment. The random lifetimes of each blade account for the changing stress environment by computing life distribution parameters for each mission point (e.g., median life if a lognormal distribution is used, characteristic life if a Weibull distribution is used), assuming constant stress at these conditions, and then forming the weighted harmonic mean of these parameters, where the weights are the fractions of total time spent at that mission condition (fᵢₖ in the example in FIG. 4). This model is a generalization of Miner's rule (1945) and assumes a linear damage accumulation process with no sequence effect (Nelson, 1990). The constant stress life parameters for each engine/blade/mission point combination are computed using a parametric life model that accounts for metal temperature y and other critical life-determining variables w. The distribution of metal temperature depends on various engine-level variables xₑ that affect all blades in the stage equally, and some blade-specific variables x_{b} whose values are unique to a given blade. A physics-based model η(xₑ, x_{b}, θ_{y}) is used in the calculation of metal temperature, so following Kennedy and O′Hagan (2001) p(y|xₑ, x_{b}, θ_{y}) is assumed to be normal, with a mean of η(xₑ, x_{b}, θ_{b})+δ(xₑ, x_{b}) and variance σ².

In using this structure, any model upgrades or data additions can be immediately accounted for in the Bayesian network, resulting in an updated uncertainty assessment of the turbine's oxidation life capability. It might also be useful to re-cast the network in terms of cumulative oxidation depth dₜ at a given time t, since much of the development and Pacer engine data will be in this form. This can be done using P(dₜ<d₀)=P(T_{d0}>t) where T_{d0} is the time until the oxidation depth reaches d₀. Reliability questions are then addressed by computing the probability that cumulative oxidation depth is less than the critical value (such as the nominal wall thickness) at some given engine age.

Those skilled in the art will readily appreciate that network interface(s) 126 described above contain the mechanical, electrical, and/or signaling circuitry communicating data to/from a wired or wireless local area network, the internet, or any other suitable network. Further, the network interface(s) 126 may be configured to transmit and/or receive data using a variety of different communication protocols without departing from the scope of this disclosure.

Memory 104 includes a plurality of storage locations that are addressable by processor(s) 102 and the network interface(s) 126 for storing software programs and data structures associated with the embodiments described herein. Note that certain embodiments of processor(s) 102 may have limited memory or no memory (e.g., no memory for storage other than for programs/processes operating on the device and associated caches). Processor 102 may include hardware elements or hardware logic adapted to execute the software programs and manipulate the data structures, e.g., data module(s) 124, reliability assessment instructions 106, and operating system 128, in memory 104. An operating system 128, portions of which are typically resident in memory 104 and executed by processor(s) 102, functionally organizes the device by, inter alia, invoking operations in support of software processes and/or services executing on the device. These software processes and/or services may include any of the methods, as described herein. Note that while these processes/services are shown in centralized memory 104, other embodiments provide for specific operation over the network interface(s) 126.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/etc.) having program instructions executing on a computer, hardware, firmware, or a combination thereof. Accordingly this description is to be taken only by way of example and not to otherwise limit the scope of the embodiments herein. Therefore, it is within the scope of this disclosure to cover all such variations and modifications as come within the true spirit and scope of the embodiments herein.

One potential advantage of using physics-based models in a Bayesian network as described above is the ability to leverage physics-based models during early stages of development that are theory rich and data poor. This can improve accuracy during early stages compared to early stage accuracy in traditional methods, by leveraging the physics-based models available together with any suitable empirical data. In later stages, the system can effectively learn through the update process and thereby improve assessment accuracy. This can also help manage engine design and development by using an integrated uncertainty quantification and updating approach. Those skilled in the art will readily appreciate that while shown and described in the exemplary context of gas turbine engines, the methods and systems described herein can be applied to any other suitable type of system without departing from the scope of this disclosure.

The methods and systems of the present invention, as described above and shown in the drawings, provide for reliability assessment with superior properties including improved accuracy prior to accumulation of empirical data by using physics-based models, the ability to update the system with empirical data, improved models, model inputs, and the like, and improved accounting for coupled sources of uncertainty. While the apparatus and methods of the subject invention have been shown and described with reference to preferred embodiments, those skilled in the art will readily appreciate that changes and/or modifications may be made thereto without departing from the spirit and scope of the subject invention.

What is claimed is:

1. A method comprising:
using a processor to carry out instructions from a memory to propagate a physics-based model through a Bayesian network to assess reliability for a gas turbine engine system.

2. A method as recited in claim 1, further comprising:
updating the physics-based model; and
propagating the updated physics-based model through the Bayesian network to reassess reliability for the gas turbine engine system.

3. A method as recited in claim 2, wherein updating the physics-based model is based on at least one of component life data, calibration data for the physics-based model, calibration data for at least one sub-model of the physics-based model, data collected in manufacturing for one or more model inputs, updated boundary conditions, and updates to the physics-based model.

4. A method as recited in claim 1, wherein propagating the physics-based model through the Bayesian network includes using nodes of the Bayesian network to characterize elements influencing reliability of at least one gas turbine engine component, wherein the nodes are interconnected with directed edges that characterize relationships among the elements influencing reliability, and wherein absence of a directed edge connecting between two of the nodes is indicative of conditional independence.

5. A method as recited in claim 1, further comprising:
collecting data from gas turbine engines in service and using the data to update the physics-based model.

6. A method as recited in claim 1, further comprising propagating at least one empirical model through the Bayesian network in combination with the physics-based model to assess reliability of the gas turbine engine system.

7. A method as recited in claim 1, wherein propagating the physics-based model through the Bayesian network includes propagating a plurality of physics-based models through the Bayesian network.

8. A method as recited in claim 7, further comprising:
updating at least one of mission and performance for at least one of the physics-based models and propagating the at least one updated physic-based model through the Bayesian network to reassess reliability.

9. A method as recited in claim 7, further comprising:
updating all of the physics-based models dependent on at least one of mission and performance with at least one of updated mission and performance; and
propagating the plurality of updated physic-based models through the Bayesian network to reassess reliability.

10. A method as recited in claim 7, further comprising:
maintaining a data module for each critical part in a gas turbine engine, wherein each data module includes data relevant to at least one of material, manufacture, assembly, green run, and service for the respective critical part of the gas turbine engine; and
using the data modules to update the physics-based models.

11. A method as recited in claim 7, further comprising:
maintaining a data module for each critical module of parts in a gas turbine engine, wherein each data module includes data relevant to at least one of material, manufacture, assembly, green run, and service for the respective module of parts of the gas turbine engine; and
using the data modules to update the physics-based models.

12. A method as recited in claim 11, further comprising receiving reliability data from operation of gas turbine engines and updating the data modules based on the reliability data.

13. A method as recited in claim 7, further comprising:
maintaining a data module for a gas turbine engine, wherein the data module includes data relevant to at least one of material, manufacture, assembly, green run, and service for the gas turbine engine; and
and using the data module to update the physics-based models.

14. A method as recited in claim 13, further comprising receiving reliability data from operation of gas turbine engines and updating the data module based on the reliability data.

15. A method as recited in claim 7, further comprising propagating at least one empirical model through the Bayesian network in combination with the physics-based model to assess reliability of the gas turbine engine system.

16. A system for assessing reliability for a gas turbine engine system comprising:
a memory including instructions to propagate a physics-based model through a Bayesian network to assess reliability for a gas turbine engine system; and
a processor operatively connected to the memory to carry out the instructions.

17. A system as recited in claim 16, further comprising a data module for each critical module of parts in a gas turbine engine, wherein each data module includes data relevant to at least one of material, manufacture, assembly, green run, and service for the respective module of parts of the gas turbine engine.

18. A system as recited in claim 17, further comprising a network interface operatively connected to the processor to receive reliability data from operation of gas turbine engines, wherein the memory includes instructions for updating the data modules based on the reliability data.

19. A system as recited in claim 16, further comprising a data module for a gas turbine engine, wherein the data module includes data relevant to at least one of material, manufacture, assembly, green run, and service for the gas turbine engine.

20. A system as recited in claim 19, further comprising a network interface operatively connected to the processor to receive reliability data from operation of gas turbine engines, wherein the memory includes instructions for updating the data module based on the reliability data.
